(19) United States
(12) Patent Application Publication
(10) Pub. No.: US 2007/0174645 A1
(43) Pub. Date: Jul. 26, 2007

(54) Multimedia video and audio player

(76) Inventor: Chung-Hung Lin, Syuejia Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/319,622

(22) Filed: Dec. 29, 2005

(51) Int. Cl. G06F 1/00

(52) U.S. Cl. 713/322

(57) ABSTRACT

A multimedia video and audio player includes an upper cover, and a main body; the upper cover includes a display screen for showing characters, figures, and images; the main body is pivoted to the upper cover, and it includes a holding recess for holding a portable multimedia player, a forwards and backwards movable fastening mechanism for fixing and electrically connecting the portable multimedia player, speakers, and volume control buttons for adjusting the sound volume; when a portable multimedia player is held in the holding recess and fastened and electrically connected by means of the fastening mechanism, signals can be transmitted from the portable multimedia player to the main body for sound to be played out through the speakers and images displayed on the display screen.

### BACKGROUND OF THE INVENTION

1. Field of the Invention

The present invention relates to a multimedia video and audio player, more particularly one, which includes a holding recess for holding a portable multimedia player, a fastening mechanism for fixing and electrically connecting the portable multimedia player, a display screen for showing images from the portable multimedia player, and speakers for playing out sound from the portable multimedia player; thus, sound from the portable multimedia player can be played out with better quality, and images more clearly shown in larger size.

2. Brief Description of the Prior Art

Video and audio players are getting smaller in size, and quality of output sound and images higher with progress of electronic technology, satisfying the consumers' need.

Home VCD and DCD players, portable CD players, portable tape players, iPOD, radios are among the currently existing video and audio players. Even desktop and laptop computers can be used to play out sound and images. Sound exists in wave format in the early days, which is gradually replaced by mp3 format because mp3 has a greater compressibility and takes up less storage space. And, portable multimedia players (PMP) are getting more common with ever increasing data capacity and size reduction of storage devices.

Portable multimedia players are easy to carry because they are small-sized and light-weighted. However, it is difficult for the elderly to clearly see the characters and images on the relatively small display screen of a portable multimedia player. Further, because the users have to wear earpieces in using the portable multimedia players, they are prone to hearing damage even though the volume of the sound output from the portable multimedia players is low.

### SUMMARY OF THE INVENTION

It is a main object of the invention to provide a multimedia video and audio player, which allows a portable multimedia player to be fitted and electrically connected thereto so that sound and images from the portable multimedia player can be played out with better quality through the multimedia video and audio player.

It is another object of the invention to provide a multimedia video and audio player, which allows signal transmission to and from an external device.

The multimedia video and audio player of the invention includes an upper cover, and a main body. The upper cover includes a display screen for showing characters, figures, and images. The main body is pivoted to the upper cover, and it includes a holding recess for holding a portable multimedia player, a forwards and backwards movable fastening mechanism for fixing and electrically connecting the portable multimedia player, speakers, and volume control buttons. When a portable multimedia player is held in the holding recess and fastened and electrically connected by means of the fastening mechanism, signals can be transmitted from the portable multimedia player to the main body for sound to be played out through the speakers and images displayed on the display screen. Therefore, sound from the portable multimedia player can be played out with better quality, and images more clearly shown.

### BRIEF DESCRIPTION OF THE DRAWINGS

The present invention will be better understood by referring to the accompanying drawings, wherein:

FIG. 1 is a perspective view of the present invention,

FIG. 2 is a partially exploded perspective view of the present invention,

FIG. 3 is a partially exploded perspective view of the invention with the fitting member for a small-sized portable multimedia player,

FIG. 4 is a rear perspective view of the present invention,

FIG. 5 is a front view of the fastening mechanism,

FIG. 6 is a partial side view of the fastening mechanism with the plate-shaped pushing part in sliding motion, and

FIG. 7 is a block diagram of the present invention.

### DETAILED DESCRIPTION OF THE PREFERRED EMBODIMENTS

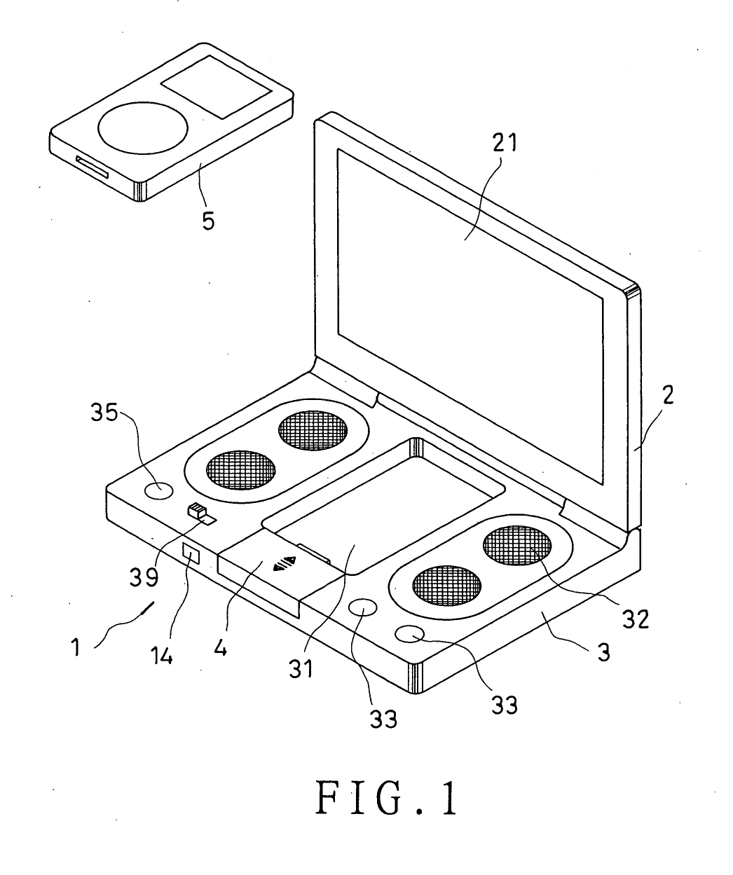

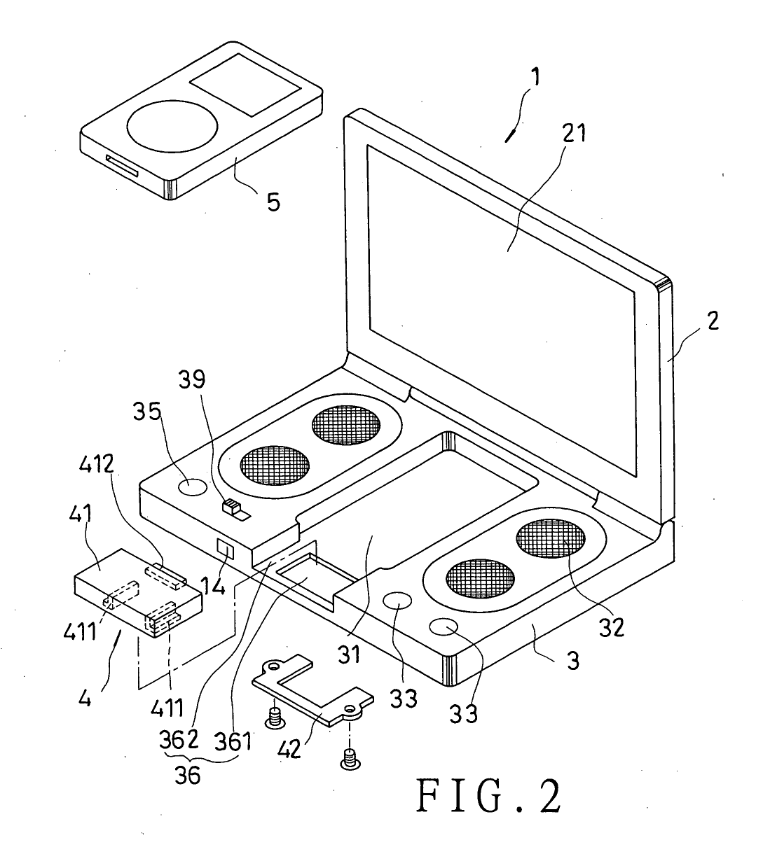

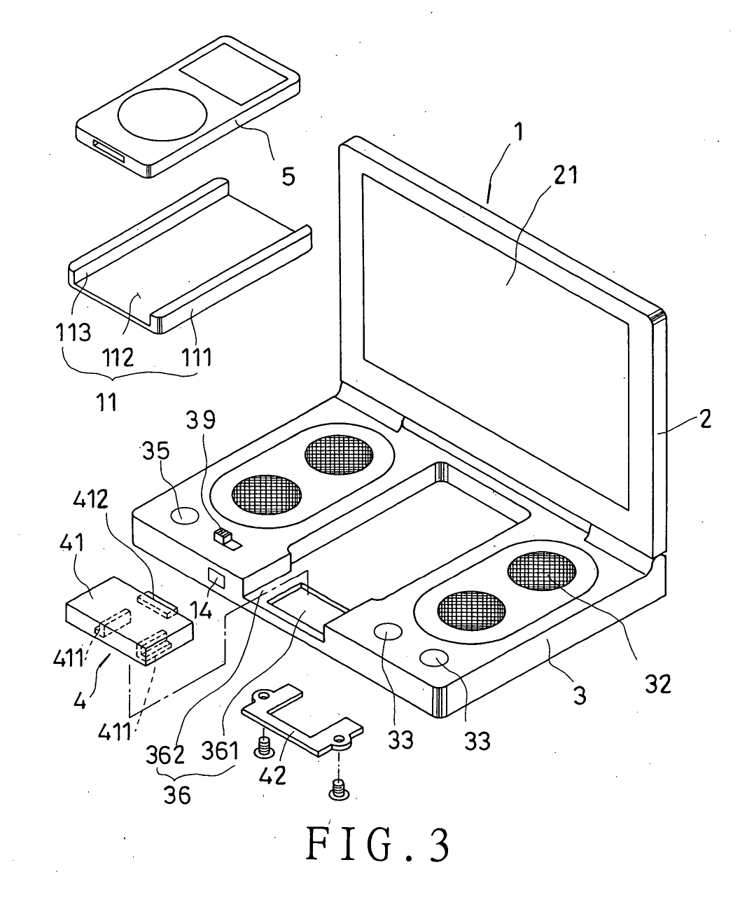

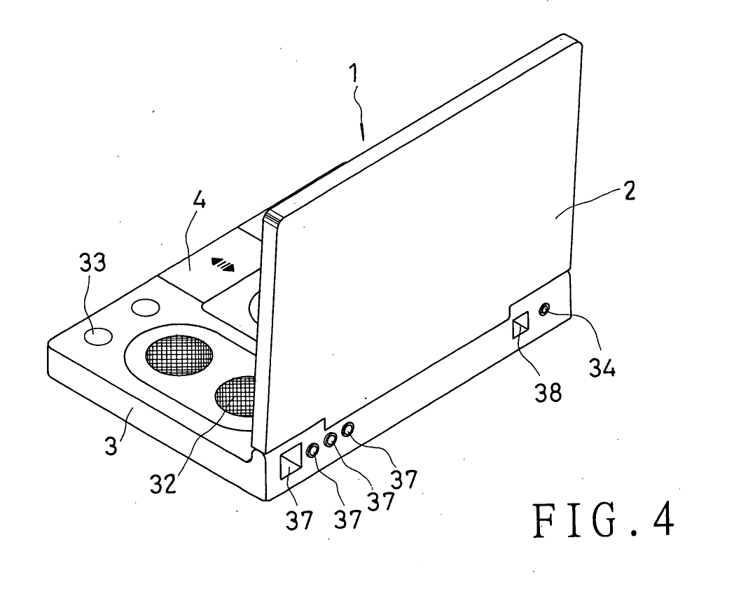

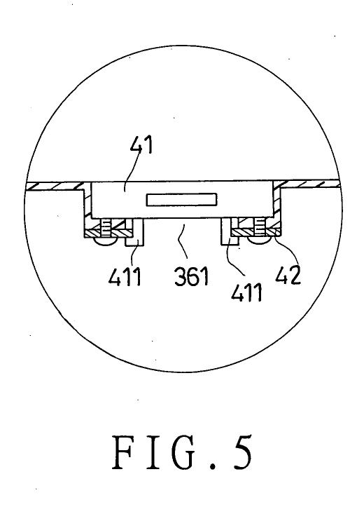

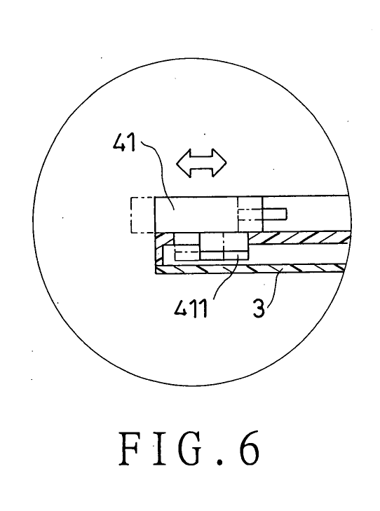

Referring to FIGS. 1 to 6, a preferred embodiment of a multimedia video and audio player 1 in the present invention includes an upper cover 2, and a main body 3.

The upper cover 2 includes a display screen 21 for showing characters, figures, pictures, and images, and it is pivoted to the main body 3 at one edge thereof. The main body 3 includes a holding recess 31, speakers 32, two volume control buttons 33, and a fastening mechanism 4. The holding recess 31 allows a portable multimedia player 5 to fit in, which portable multimedia player 5 can be an iPod, mobile phone, PDA or other appropriate digital video and audio equipments. The fastening mechanism 4 can be moved forwards and backwards on the main body 3; the fastening mechanism 4 will fasten the portable multimedia player 5 fitted in the holding recess 31 when it is pushed forwards. The two volume control buttons 33 are used to control the volume, more specifically they are used to increase and reduce the volume respectively. Therefore, sound from the portable multimedia player 1 can be played out with better quality, and images more clearly shown in larger size through the speakers 32 and the display screen 21 of the multimedia video and audio player 1. Consequently, the portable multimedia player 1 has excellent performance in presenting colorful figures and pictures, animation, films, music, and sound.

The multimedia video and audio player 1 of the present invention can be powered with built-in batteries or an external power supply; the main body 31 has a power socket 34, which allows electrical connection to an external power supply, and it has a power switch 35 used for turning on and off the power. If a portable multimedia player 5 having a smaller size than the holding recess 31 is to be used with the multimedia video and audio player 1, the player 1 has to be equipped with a fitting member 11, which is fitted in the holding recess 31, and which includes an outer frame 111 fitting the holding recess 31, an inner frame 112 having an internal space fitting a small-sized portable multimedia player 5 such as an iPod Nano, and a gap 113 abutting the internal space of the inner frame 112; thus, the small-sized portable multimedia player 5 can be held steady on the present invention. Furthermore, the gap 113 of the fitting member 11 will face the fastening mechanism 4 after the fitting member 11 is fitted in the holding recess 31.

In the present preferred embodiment, the fastening mechanism 4 includes a plate-shaped pushing part 41, and a flat limiting part 42 while the main body 3 has a gap 36, a through hole 361 communicating with the gap 36 on a bottom side thereof, and step-shaped portions 362 around the through hole 361. The plate-shaped pushing part 41 has two L-shaped hooks 411 facing in opposite directions on a bottom side thereof, and a connecting element 412 at a front end, which is to be inserted into a portable multimedia player 5 for data transmission. The flat limiting part 42 has a [symbol] -shape, and it is fixed right under the gap 36. The plate-shaped pushing part 41 is fitted in the gap 36 and pressed against the step-shaped portions 362 in a forwards and backwards movable manner with the L-shaped hooks 411 being passed through the through hole 361 and hooked over inward edges of the flat limiting part 42. After the connecting element 412 is fitted in one end of a portable multimedia player 5 held in the holding recess 31, signals are allowed to be transmitted from the portable multimedia player 5 to the inside of the main body 3. It should be understood that the portable multimedia player fastening structure of the present invention is not limited by the above embodiment by the modification of design in each element.

The main body 3 is further equipped with a signal socket 37, a connecting device 38, and a signal switch 39 in order to allow signal transmission from equipments other than the portable multimedia player 5. The signal socket 37 allows an external device to be electrically connected thereto so that video and audio signals can be input/output, and it can be an AV terminal, S-terminal or other types of connecting structures.

The connecting device 38 allows various kinds of external platforms, e.g. personal computers, portable disks, card readers, and flash memories, to be connected thereto so that data can be input/output into/from the main body 3. The connecting device 38 can be USB, IEEE 1394 or other connectors that are suitable for use on computer accessories. The signal switch 39 is used to choose the signal source of the display screen 21 and the audio signal source; for example, video and audio signals can come from a portable multimedia player 5 or the signal socket 37.

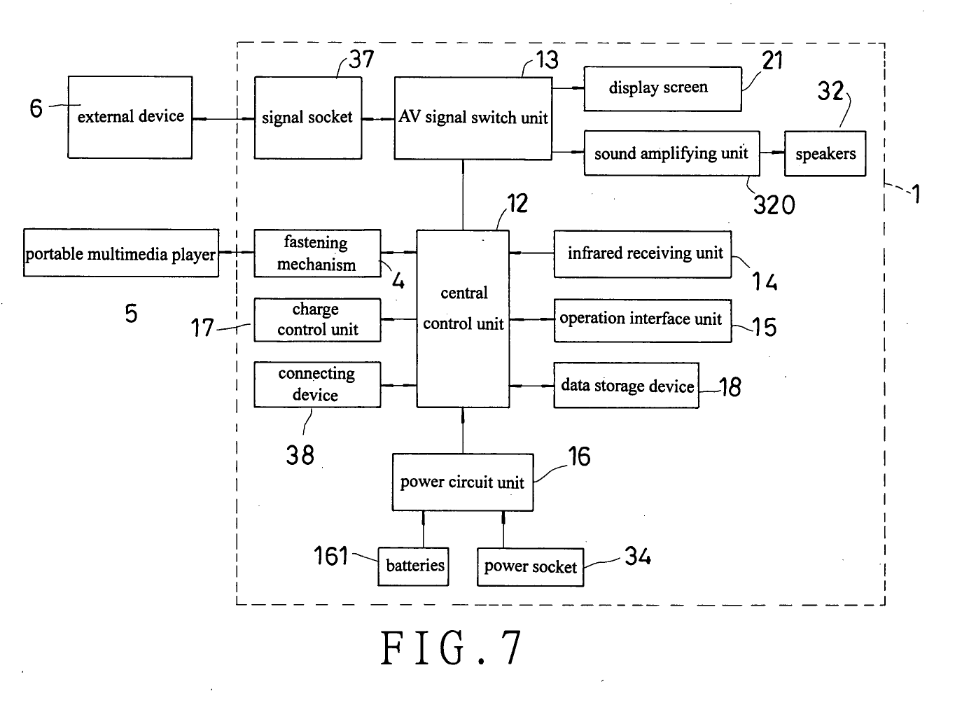

Referring to FIGS. 1 and 7, the multimedia video and audio player 1 of the present invention includes a central control unit 12, an AV signal switch unit 13, an infrared receiving unit 14, an operation interface unit 15, a power circuit unit 16, a charge control unit 17, a data storage device 18, a display screen 21, speakers 32, and a connecting device 38; the display screen 21 is used for showing animations, and it can be an LCD screen or other kinds of thin display screens; the speakers 32 are used for sound output.

The central control unit 12 is used for coding and decoding of input/output video and audio data, and used as the core of control and processing of other signals, and it is connected to the AV signal switch unit 13. The AV signal switch unit 13 is connected to the display screen 21 and the speakers 32. Further, a sound amplifying unit 320 is interposed between the AV signal switch unit 13 and the speakers 32 to adjust the sound volume, filter out noise, set the surrounding mood, and effect uniformity of the sound quality, thus enhancing the quality of music and sound. Further, an external device 6 can be electrically connected to the AV signal switch unit 13 through the signal socket 37 to input/output signals, which external device 6 can be a TV, digital broadcasting device, digital TV signals or other similar video and audio players.

The infrared receiving unit 14 is used to receive wireless signals, which are then sent to the central control unit 12; more particularly, the wireless signals are sent out from a remote control. The operation interface unit 15 is connected to the central control unit 12 to control video and audio signals output from the multimedia video and audio player 1; the operation interface unit 15 can be the volume control buttons 33 allowing the user to input commands to control the sound volume; the operation interface unit 15 can be the signal switch 39 allowing the user to choose the signal source.

Further, the central control unit 12 can be electrically connected to the portable multimedia player 5 through a connecting base to allow transmission of signals, which are then processed by means of the central control unit 12, and video and audio signals are input into the display screen 21, and the speakers 32.

The connecting device 38 allows various kinds of external platforms to be connected thereto to input/output data into/from the central control unit 12. Further, the central control unit 12 is connected to the data storage device 18 for data storage; the data storage device 18 can be a hard disk, memory or other devices suitable for data storage. The power circuit unit 16 provides power to electric and electronic parts inside the portable multimedia player 5. The power circuit unit 16 can be connected to batteries 161, or alternatively it can be connected to the power socket 34 to be powered with the utility grid or car power supply through a power converter. The power switch 35 is used to turn on/off the power.

The fastening mechanism 4 is connected to the central control unit 12 so that after a portable multimedia player 5 is connected to the fastening mechanism 4, signals can be input into and output from the central control unit 12. The charge control unit 17 is interposed between the central control unit 12 and the fastening mechanism 4 so that the portable multimedia player 5 can be charged with the charge control unit 17.

Therefore, after a portable multimedia player 5 is fitted in the holding recess 31, and fastened and electrically connected with the fastening mechanism 4, signals from the portable multimedia player 1 are transmitted to the main body 3, and in turn sound is sent out through the speakers 32, and images shown on the display screen 21. When the upper cover 2 is pivoted down to cover the main body 3, the display screen 21 is protected from damage and scratching.

From the above description, it can be easily seen that the present invention has the following advantages:

1. Images can be presented with better quality and in larger size on the display screen of the multimedia video and audio player, and the speakers can play out three-dimensional sound, and in turn music, voice, and talk will be clearer. Furthermore, the present invention illuminates the need for the user to wear earpieces to listen to music, preventing damage to the user's hearing.

2. The upper cover can be pivoted close to the main body to protect the display screen from damage and scratching and make the whole multimedia video and audio player easy to carry.

What is claimed is:

1. A multimedia video and audio player, comprising
(a) an upper cover; the upper cover including a display screen for showing characters, figures, pictures, and images;
(b) a main body pivoted to the upper cover at one edge thereof; the main body including:
a holding recess for holding a portable multimedia player;
a fastening mechanism for fastening a portable multimedia player held in the holding recess; the fastening mechanism being movable forwards and backwards;
a plurality of speakers; and
a plurality of volume control buttons for controlling volume of output sound;
the fastening mechanism being going to electrically connect a portable multimedia player when the portable multimedia player is held in the holding recess and fastened with the fastening mechanism, thus allowing signals to be transmitted from the portable multimedia player to the main body for sound and images to be presented through the speakers and the display screen.

2. The multimedia video and audio player as claimed in claim 1 further comprising a fitting member, which includes an outer frame fitting the holding recess of the main body, an inner frame having an internal space, and a gap abutting the internal space of the inner frame; the fitting member being fitted in the holding recess of the main body with a small-sized portable multimedia player, which is smaller than the holding recess, being fitted in the inner frame thereof so that the small-sized portable multimedia player is fixed in position; the gap being going to face the fastening mechanism when the fitting member is fitted in the holding recess of the main body.

3. The multimedia video and audio player as claimed in claim 1, wherein the main body has a gap, a through hole communicating with the gap on a bottom side thereof, and step-shaped portions around the through hole while the fastening mechanism includes:
a plate-shaped pushing part; the plate-shaped pushing part having two L-shaped hooks facing in opposite directions on a bottom side thereof, and a connecting element at a front end, which will allow data transmission when inserted into a portable multimedia player; and
a flat limiting part having a [symbol] -shape; the flat limiting part being fixed right under the gap of the main body;
the plate-shaped pushing part being fitted in the gap of the main body and pressed against the step-shaped portions in a forwards and backwards movable manner with the L-shaped hooks being passed through the through hole and hooked over inward edges of the flat limiting part.

4. The multimedia video and audio player as claimed in claim 1, wherein the main body includes:
a central control unit; the central control unit allowing a portable multimedia player to be connected thereto and being used for coding and decoding input/output video and audio data and used as a core of control and processing of other signals;
an AV signal switch unit connected to the central control unit; the AV signal switch unit having a first end allowing an external device to be connected thereto for input of video and audio signals; the AV signal switch unit having a second end, which allows video and audio signals to be transmitted to the display screen and the speakers through it;
an operation interface unit connected to the central control unit for allowing a user to input operation commands; and
a power circuit unit for providing power to electric and electronic parts inside the portable multimedia player.
